(19) United States
(12) Patent Application Publication
(10) Pub. No.: US 2021/0017846 A1
(43) Pub. Date: Jan. 21, 2021

(54) CONTROL SCHEME FOR SURFACE STEERABLE DRILLING SYSTEM

(71) Applicant: Petex Energy, Inc., Katy, TX (US)

(72) Inventor: Geng Sun, Beijing (CN)

(21) Appl. No.: 16/511,096

(22) Filed: Jul. 15, 2019

(51) Int. Cl. E21B 44/00; E21B 7/04; E21B 3/02; G06N 20/00

(52) U.S. Cl. CPC E21B 44/00; G06N 20/00; E21B 3/02; E21B 7/04

(57) ABSTRACT

A method for creating and using a control scheme for a drilling operation that includes collecting a set of on-site drilling data for mud motor sliding drilling, wherein the set of on-site drilling data includes information related to at least one of drilling information, rig information, real time data on the drilling operation, and combinations thereof; and division of the set of data from the collecting step into two categories according to a certain proportion. Some of the better-performing data is categorized as an A-class, and the rest as a B-class import system database.

### BACKGROUND

### Field of the Disclosure

This disclosure generally relates to tools used in oil and gas wellbores. More specifically, the disclosure relates to downhole drilling systems that include use of a drill string run into a wellbore and operable to drill a wellbore. In particular embodiments, the drilling system may be for directional drilling, and may include a steerable system controlled from the surface.

### Background of the Disclosure

A hydrocarbon-based economy continues to be a dominant force in the modern world. As such, locating and producing hydrocarbons continues to demand attention from the oil and gas (O&G) industry. Once hydrocarbons have been found, a well is formed in a surrounding formation so that valuable fluids therein may be produced, and later refined into commercial products, such as gasoline or natural gas.

A well or wellbore is generally drilled in order to recover valuable hydrocarbons and other desirable materials trapped in geological formations in the Earth. A wellbore is typically drilled using a drill bit attached to the lower end of a “drill string.” The drill string is a long string of sections of drill pipe that are connected together end-to-end. Drilling fluid (or “mud”) is pumped down to the drill bit, primarily to lubricate and cool the drill bit, and also carry drill cuttings back to the surface.

In conventional drilling, the wellbore is drilled to a predetermined position, and then lined with a larger-diameter pipe (e.g., casing). To accomplish this, the drill string and the drill bit is removed from the wellbore (e.g., tripping). Once removed, the casing is lowered into the well and cemented in place.

The process of drilling a well typically includes a series of drilling, tripping, casing and cementing, and repeating as necessary. FIG. 1 shows a simplified view of a conventional drilling operation. A derrick 102 (or drilling rig) is configured to rotate a drill string 104 that has a drill bit 106 disposed at a lower end of the drill string 104. As it rotates, the drill bit 106 forms the wellbore 108. The rotation may be with the use of a top drive 110 (with elevator, drive frame, etc.). Similarly, when it is desired to trip the drill string 104 into or out of the wellbore 108, the drive 110 is lowered or raised. Additionally, during servicing operations, the drill string 104 is moved longitudinally into or out of the wellbore 108.

To aid drilling, a MWD (measurement while drilling) collar 112 is positioned just above the drill bit 106, which is configured to take measurements relating to the properties of the formation as the wellbore 108 is drilled.

The top drive 110 is a common drilling component that directly rotates the drill string 104 from the derrick 102. The top drive 110 operates to feed down the drill pipe along a special guide rail to complete rotary drilling, circulate the drilling fluid, connect the drill pipes, and make up the connections and reciprocate the drill string 104, and a variety of drilling operations.

Common to drilling today is the process called “directional drilling”, which refers to the purposeful deviation of the wellbore 108 from what would otherwise be a vertical path. Directional drilling may be contemplated as the steering of the drill string 104 so that it travels in a desired direction. Directional drilling is prevalently used with horizontal directional drilling or HDD, which enables a longer length of the wellbore 108 to traverse the desired part of the formation.

One method of directional drilling uses a bottom hole assembly (“BHA”) that includes a bent housing and a mud motor (briefly described but not shown here). With a bent housing, the drill string 104 is not rotated from the surface, but instead, the drill bit 106 is pointed in the desired drilling direction, and rotated by a mud motor located in the BHA in a manner known to one of skill in the art. For the straight drilling, the entire drill string 104, including the bent housing, is rotated from the surface.

Directional drilling is a very complicated process. While not limited, the conditions that can affect the drilling state are generally divided into the following categories: 1) formation causes; 2) drilling rig conditions, and 3) the real time drilling parameters. These conditions more specifically may pertain to: the compressive strength of the formation, the dip angle of the formation, and the heterogeneity, downhole BHA, drilling fluid, and torque, rotational speed, angular position, torsional transmission lag time, torsional transmission characteristic parameters, etc.

In the process of directional drilling, the drill string 104 is sometimes only sliding and not rotating, and the downhole well 108 is drilled along the motor bent, which this is referred to as sliding drilling. Such sliding drilling has a large static friction resistance during drilling because the entire drill string 104 is in a sliding state (non-rotating state).

In the tangential section (drilling straight along the current direction), while the downhole bit 106 is drilling, the drill string 104 is rotated at a certain speed to eliminate the influence of the angle of the curved shell, so that the drill string 104 remains in the current wellbore direction, which is called rotating drilling. During rotating, the whole drill string 104 rotates at a certain speed, so the static friction resistance during the drilling process is converted into relatively small dynamic friction resistance, thus the resistance is relatively small

At present, slide drilling with a mud motor (combined with MWD technology) is still a common method in directional drilling. In order to improve the overall efficiency of directional drilling, the surface steering system is usually used together.

In current directional wells, horizontal wells, and large displacement horizontal wells, during the sliding process, a large static friction force is generated which caused a resistance that hinders the drill string from sliding down the drill. The most common practice is to periodically pick up the drill string to reciprocate it, or to improve the lubrication by replacing the drilling fluid. These common practices do not serve well normally. In the end, the efficiency of drilling is detrimentally affected, and the drilling depth of horizontal wells is limited.

More recently, a kind of torque rocking technology has been developed. The torque or angle of the top drive rotation is controlled to rotate in the forward and reverse directions to make the reciprocating rotation occur near the ground, and meanwhile the drill string near the section of the drill remains in a sliding state, thereby ensuring that the tool face is unchanged.

However, these methods still utilize manual control of the top drive, which is inefficient and time consuming.

Moreover, a control system of a typical ground-oriented system is a nonlinear, time-varying, multi-input and output control system. Due to too many input parameters, strong coupling between parameters, and high nonlinearity, the traditional linearization approximation method cannot be applied to the control system.

Existing control methods usually give up the consideration of the overall optimization, and instead utilize a single parameter as a control basis, and consider the remaining influencing factors as constant or ideal state. Control strategies like this include: surface torque-based control method, angle position-based control method, toolface direction-based control method, and so on. However, any such control strategy based on such a simplified model is difficult to adapt to the highly-variable and ever-changing drilling process, resulting in the general low drilling efficiency, and even the situation that the drilling task cannot be completed.

The state of the technology today has multiple disadvantages. First, the length of the drill pipe in the rotating state, the theoretical maximum value is the distance between the surface to a point where the tool face will be affected. This zone of rotation normally will be well below this maximum value to make a safety margin to make sure the tool face will not change during sliding. This small zone of rotation will limit the static friction resistance reduction.

Next, after the rotation of the drill string, the torque rocking system needs to perform the torque holding process, at which time the entire drill pipe is kept in a non-rotating state, and the total friction at this time is the direct sliding friction, reaching the maximum value of the friction. The weight is often not transmitted to the drill bit. The weight may only cause the drilling tool to buckle, randomly form a new friction point, and store the torque in the drill string. For another disadvantage, the torque stored in the drill pipe will induce a random distribution of the torque accumulation in the drill pipe and a random distribution of the buckling friction points. This will result in poor controllability and stability of the drill string. Finally, torque stored in the drill pipe may also cause the accumulation of torque in the drill pipe and cause uncontrollable swinging of the drill pipe.

The ability to increase efficiency and save operational time (and thus saving operational costs) leads to considerable competition in the marketplace. Achieving any ability to save time, or ultimately cost, leads to an immediate competitive advantage. Thus, there is a need in the art for a drilling system that does not require extensive time (or incur difficulties) or difficulty in utilizing a top drive. There are needs in the art for novel systems and methods for controlling a drilling system, and particularly improved control and automation of a top drive.

### SUMMARY

Embodiments of the disclosure pertain to a top drive drilling control optimization scheme. This type of top drive external control device may communicate with an original or dedicated control system of the top drive, may take over part of the function of the top drive, and may control the top drive to perform a series of operations to achieve the purpose of optimizing drilling. The scheme may be suitable to deal with complex structural wells, ultra-deep wells, super-large displacement wells, deep water wells and special process wells under complex geological conditions.

The top drive external control may include some one or more controls scheme parameters, and may also be used to different type of known top drives. In the presence of excessive friction, low sliding efficiency or other complicated conditions, the top drive external control device may communicate with the target top drive to optimize the control logic of the top drive and improve the drilling efficiency and safety

Embodiments herein pertain to a surface steering system operable to provide a new generation of dedicated drilling device. The surface steering system may include a control scheme. The control scheme may be part of or associated with a module configured to be installed in or associated with an operator station (e.g., dog house), which may be on a rig floor or other suitable surface facility. By taking over part of the function of the top drive, combined with the on-site measurement parameters and the operator's instructions (i.e., commands, etc.), interference of the slide drilling may be achieved according to the established rules or algorithms. The top drive may be automatically controlled, which greatly reduces the workload of the field operator, and at the same time enables more and faster continuous control of the top drive.

Embodiments herein provide for a method for creating and using a control scheme for a drilling operation that may include one or more steps of: collecting a set of on-site drilling data from the drilling operation; and dividing the set of on-site drilling data into an at least two class categories according to predetermined selectivity definitions. One of the class categories may be an A-class comprising better performing data.

The steps may include performing distributed data processing comprising an at least one of: data sorting, data format conversion, data classification, and combinations thereof; and processing the set of data as an at least one training sample.

Other steps may include to establish a set of evaluation system to comprehensively evaluate advantages and disadvantages from aspects of ROP, drilling efficiency, and sliding ratio associated with the drilling operation. Yet another step may include to establish a deep learning module by using the at least one training sample to train the deep learning module, such as through an iterative training mode.

In aspects associated with the control scheme, a drilling simulation platform may be used to simulate at least a portion of the drilling operation. An optimal control logic under a calculation time step may be found from repeated calculations over a pre-determined time, which may obtain or yield an at least one simulation training sample.

A support vector machine classification method may be used to classify the at least one training sample. The SVM classification may use an at least one control parameter to account for varied well conditions.

Any control parameter may include an at least one of: effects from a surrounding formation, a drilling operation tool, a real-time parameter from the drilling operation, and combinations thereof.

The method may include one or more (sub)steps, such as: determining a set of missing information by adding a hidden layer in the module to specifically handle the determining the set of missing information via strong association. In aspects, the hidden layer may get or obtain data from a missing information unit. As such, the hidden layer may output one or more data streams to any cell of a next hidden layer.

The method may include the step of: using machine learning control to perform a simulated sliding drilling operation. The method may include (such as via machining learning) the step of to perform iterative training with reference to the set of evaluation system in order to update the control scheme parameters.

In aspects, after the using machine learning step, the method may include using the A-class data in a manner to fine tune the machine learning control.

Other embodiments herein pertain to a method for creating and using a control scheme for a drilling operation that may include one or more of: collecting a set of on-site drilling data from the drilling operation comprising sliding drilling; dividing the set of on-site drilling data into an at least two class categories according to predetermined selectivity definitions, whereby one of the class categories is an A-class comprising better performing data, and another class category is a B-class; performing distributed data processing comprising an at least one of: data sorting, data format conversion, data classification, and combinations thereof; processing the set of data as an at least one training sample; establishing a set of evaluation system to comprehensively evaluate advantages and disadvantages from aspects of associated with the drilling operation; and/or establishing a deep learning module by using the at least one training sample to train the deep learning module through an iterative training mode.

In aspects, a drilling simulation platform may be used to simulate at least a portion of the drilling operation. An optimal control logic under a calculation time step may be found from repeated calculations over a pre-determined time in order to obtain an at least one simulation training sample.

Still other embodiments of the disclosure provide for a method for creating and using a control scheme for a drilling operation that may include one or more steps of: collecting a set of on-site drilling data for mud motor sliding drilling, wherein the set of on-site drilling data includes information related to at least one of drilling information, rig information, real time data on the drilling operation, and combinations thereof; division of the set of data from the collecting step into two categories according to a certain proportion, whereby some of the better-performing data is categorized as an A-class, and the rest as a B-class import system database; and establishing the control scheme based on the model of the drill bit and the interaction between the drill string and the formation, and the finite element analysis of the entire drilling operating.

The control scheme may be a SVM-based multi-parameter automatic real-time control scheme.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1 is a side view of a process diagram of a conventional top drive drilling system;

FIG. 2A shows a simplified schematic view of a drilling system according to embodiments of the disclosure;

FIG. 2B shows a schematic block view of a control scheme having an auxiliary interface unit operable with a top drive according to embodiments of the disclosure;

FIG. 2C shows an external front downward modular view of a control module according to embodiments of the disclosure;

FIG. 2D shows an external frontside view of the control module of FIG. 2C according to embodiments of the disclosure;

FIG. 2E shows an external side view of the control module of FIG. 2C according to embodiments of the disclosure;

FIG. 2F shows a schematic block view of the control module according to embodiments of the disclosure;

FIG. 3 shows a schematic flow diagram of a control scheme according to embodiments of the disclosure;

FIG. 4 shows a network control scheme configured to open an at least one hidden layer according to embodiments of the disclosure;

FIG. 5 shows a logic circuit decision tree operable as part of a network control scheme according to embodiments of the disclosure; and

FIG. 6 shows block steps for a method of creating and using a control scheme according to embodiments of the disclosure.

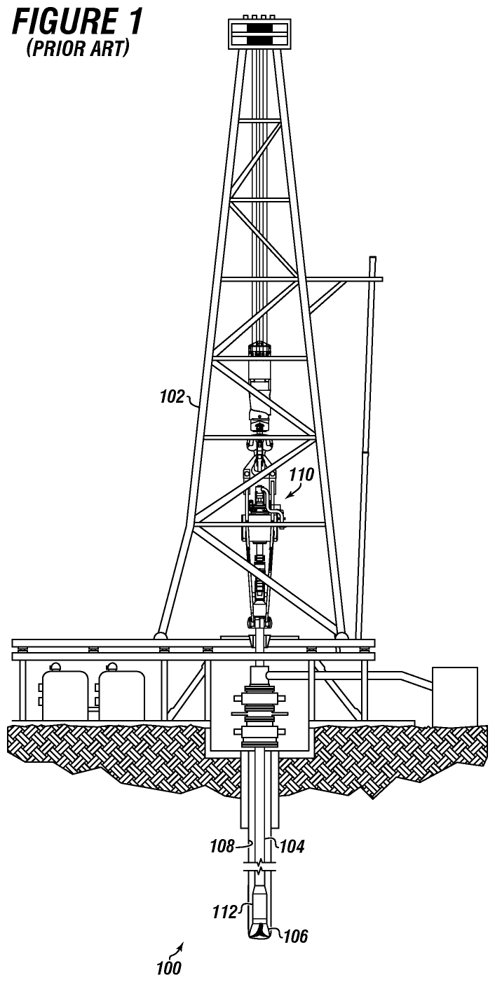

### DETAILED DESCRIPTION

Regardless of whether presently claimed herein or in another application related to or from this application, herein disclosed are novel apparatuses, units, systems, and methods that pertain to improved fluid processing, which may include separation, testing, and aspects related thereto, details of which are described herein.

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any particular component, subcomponent, etc., may be as would be apparent to one of skill in the art, such as molding, forming, press extrusion, machining, or additive manufacturing. Embodiments of the disclosure provide for one or more components to be new, used, and/or retrofitted to existing machines and systems.

Various equipment may be in fluid communication directly or indirectly with other equipment. Fluid communication may occur via one or more transfer lines and respective connectors, couplings, valving, piping, and so forth. Fluid movers, such as pumps, may be utilized as would be apparent to one of skill in the art.

Numerical ranges in this disclosure may be approximate, and thus may include values outside of the range unless otherwise indicated. Numerical ranges include all values from and including the expressed lower and the upper values, in increments of smaller units. As an example, if a compositional, physical or other property, such as, for example, molecular weight, viscosity, melt index, etc., is from 100 to 1,000. it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure. Numerical ranges are provided within this disclosure for, among other things, the relative amount of reactants, surfactants, catalysts, etc. by itself or in a mixture or mass, and various temperature and other process parameters.

### Terms

The term “connected” as used herein may refer to a connection between a respective component (or subcomponent) and another component (or another subcomponent), which can be fixed, movable, direct, indirect, and analogous to engaged, coupled, disposed, etc., and can be by screw, nut/bolt, weld, and so forth. Any use of any form of the terms “connect”, “engage”, “couple”, “attach”, “mount”, etc. or any other term describing an interaction between elements is not meant to limit the interaction to direct interaction between the elements and may also include indirect interaction between the elements described.

The term “fluid” as used herein may refer to a liquid, gas, slurry, single phase, multi-phase, pure, impure, etc. and is not limited to any particular type of fluid such as hydrocarbons.

The term “fluid connection”, “fluid communication,” “fluidly communicable,” and the like, as used herein may refer to two or more components, systems, etc. being coupled whereby fluid from one may flow or otherwise be transferrable to the other. The coupling may be direct, indirect, selective, alternative, and so forth. For example, valves, flow meters, pumps, mixing tanks, holding tanks, tubulars, separation systems, and the like may be disposed between two or more components that are in fluid communication.

The term “pipe”, “conduit”, “line”, “tubular”, or the like as used herein may refer to any fluid transmission means, and may be tubular in nature.

The term “composition” or “composition of matter” as used herein may refer to one or more ingredients, components, constituents, etc. that make up a material (or material of construction). Composition may refer to a flow stream of one or more chemical components.

The term “chemical” as used herein may analogously mean or be interchangeable to material, chemical material, ingredient, component, chemical component, element, substance, compound, chemical compound, molecule(s), constituent, and so forth and vice versa. Any ‘chemical’ discussed in the present disclosure need not refer to a 100% pure chemical. For example, although ‘water’ may be thought of as H2O, one of skill would appreciate various ions, salts, minerals, impurities, and other substances (including at the ppb level) may be present in ‘water’. A chemical may include all isomeric forms and vice versa (for example, “hexane”, includes all isomers of hexane individually or collectively).

The term “water” as used herein may refer to a pure, substantially pure, and impure water-based stream, and may include waste water, process water, fresh water, seawater, produced water, slop water, treated variations thereof, mixes thereof, etc., and may further include impurities, dissolved solids, ions, salts, minerals, and so forth. Water for a frac fluid can also be referred to as ‘frac water’.

The term “skid” as used herein may refer to one or more pieces of equipment operable together for a particular purpose. For example, a ‘well tester skid’ may refer to one or more pieces of equipment operable to provide or facilitate a testing process related to a well. A skid may be mobile, portable, or fixed. Although ‘skid’ may refer to a modular arrangement of equipment, as used herein may be mentioned merely for a matter of brevity and simple reference, with no limitation meant. Thus, skid may be comparable or analogous to zone, system, subsystem, and so forth.

The term “skid mounted” as used herein may refer to one or more pieces operable together for a particular purpose that may be associated with a frame- or skid-type structure. Such a structure may be portable or fixed.

The term “utility fluid” as used herein may refer to a fluid used in connection with the operation of a heat generating device, such as a lubricant or water. The utility fluid may be for heating, cooling, lubricating, or other type of utility. ‘Utility fluid’ can also be referred to and interchangeable with ‘service fluid’ or comparable.

The term “mounted” as used herein may refer to a connection between a respective component (or subcomponent) and another component (or another subcomponent), which can be fixed, movable, direct, indirect, and analogous to engaged, coupled, disposed, etc., and can be by screw, nut/bolt, weld, and so forth.

The term “sensor” as used herein can refer to a device that detects or measures a physical property and may record, indicate, or otherwise respond to it. The output of a sensor can be an analog or digital signal.

The term “module” as used herein can refer to a system component (with one or more subcomponents) that may have an associated control scheme. The module may be operably connected with one or more components that may be part of a drilling system. For example, the module may be connected (or interfaced, etc.) with a top drive.

The term “microprocessor” as used herein can refer to a logic chip or a computer processor on a microchip. The microprocessor may have most or all central processing unit (CPU) functions.

The term “microcontroller”, “programmable logic controller”, “PLC”, and the like, as used herein can refer to a CPU with additional function or structure, such as RAM, ROM, and or peripherals like I/O all embedded on a single chip.

The term “computer readable medium” (CRM) as used herein can refer to any type of medium that can store programming for use by or in connection with an instruction execution system, apparatus, or device. The CRM may be, for example, a device, apparatus, or system based on electronic, magnetic, optical, electromagnetic, or semiconductor function. By way of further example, the CRM may include an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical).

The term “Wi-Fi module” as used herein can refer to a device or logic circuit that provides ability for a microcontroller to communicate data to a network, as well as update firmware and code inside the microcontroller.

The term “mud motor slide drilling” or “slide drilling” as used herein may refer to a drilling process (or system) that utilizes orientation of a drill bit to a desired bit trajectory. During slide drilling the bit may be pulled off bottom (of the well), and the drill string reciprocated to release any undesired torque. A downhole mud motor may then be oriented, and the bit (but not the drill string) rotated.

The term “linearization approximation method” as used herein may refer to a mathematical approximation of a general function using a linear function (more precisely, an affine function). Such a method may be in the method of finite differences to produce first order methods for solving or approximating solutions to equations.

The term “control algorithm” as used herein may refer to a mathematical representation of the control action to be performed.

The term “big data” as used herein may refer to a large number of drilling databases for model training.

The term “on-site drilling data” as used herein may refer to field drilling data (such as well log, bottom hole assembly and so on), which may be suitable for model training.

The term “actual training sample” as used herein may refer to the training samples from practical drilling operations, which can be used for training control model.

The term “simulation training sample” as used herein may refer to training samples from simulation drilling calculation of simulation platform, which can also be used for training control model.

The term “test sample” as used herein may refer to a training sample.

The term “drilling simulation platform” as used herein may refer to a type of simulator suitable to iterate a certain drilling condition(s) to get an appropriate control strategy.

The term “optimal control logic” as used herein may refer to a reasonable drilling strategy obtained by iteration in the simulator for a well under certain conditions.

The term “support vector machine (SVM) classification” as used herein may refer to a classification method based on support vector machine (SVM).

The term “deep learning model” as used herein may refer to a control model that may be based on deep learning theory. Deep learning (also known as deep structured learning or hierarchical learning) is part of a broader family of machine learning methods based on artificial neural networks.

The term “supervised learning method” as used herein may refer to a type of machine learning. In supervised learning, each sample is a pair of input objects (usually a vector) and an expected output value (also known as supervised signals).

The term “algorithm parameters” as used herein may refer to one or more parameters suitable for a deep learning model. “The deep learning model with the parameters obtained by training” may be referred to as a control model, control scheme, control algorithm, and so forth.

The term “connection weight” as used herein may refer to a neural network model, whereby the connections of the biological neuron are modeled as weights, also called as connection weight.

The term “neural network model” as used herein may refer to a control model based on the artificial neural network technology.

The term “optimal control” as used herein may refer to a reasonable drilling strategy obtained by iteration in the simulator for a well under certain conditions.

The term “hidden layer” as used herein may refer to an artificial neural network, whereby a series of units that receive information from input layer and process all information.

The term “new hidden layer” as used herein may refer to a modified model, whereby a new hidden layer has been added between input layer and hidden layer.

The term “input layer” as used herein may refer to an artificial neural network, whereby the input layer receives information from the outside and transmits it to the hidden layer.

The term “output layer” as used herein may refer to an artificial neural network, whereby the output layer receives the information processed by the artificial neural network and sends the result to the external receiver.

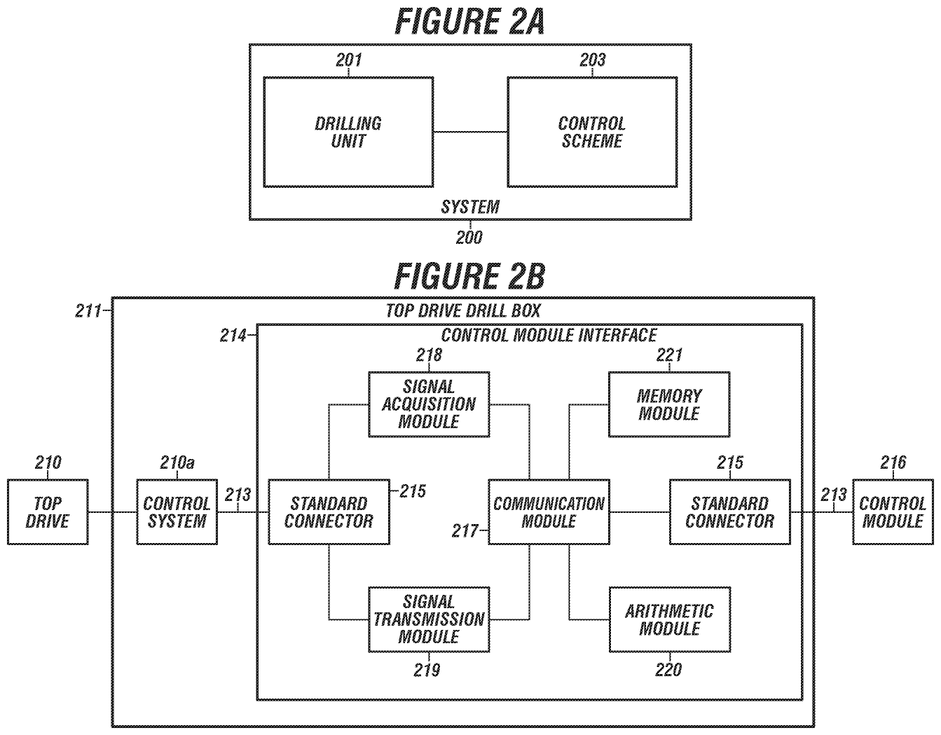

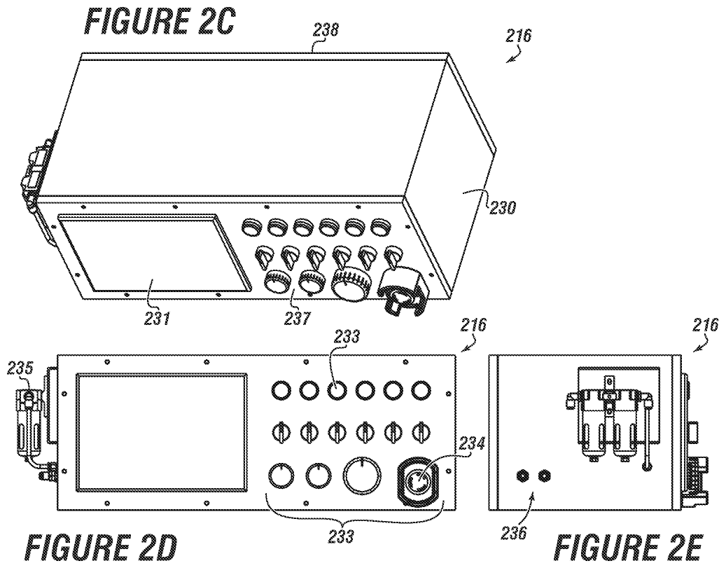

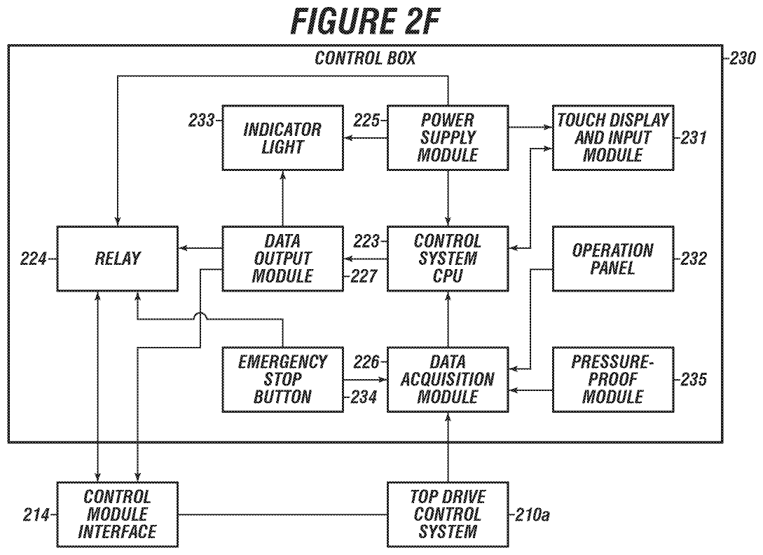

Referring now to FIGS. 2A-2E together, a simplified schematic view of a drilling system 200, a schematic block view of a control scheme operable with a top drive, a schematic block view of an auxiliary interface unit, an external modular view of a control module, and a schematic block view the control module, illustrative of embodiments disclosed herein, are shown. Embodiments herein provide for a machine learning method for big data, which can form a set of control algorithms through a large amount of training and is suitable for automatic control of the surface steering system 200.

FIGS. 2A-2E together depict the system 200 may be operable to achieve one or more above objectives as described herein by performing one or more of the following:

Extensively collect on-site drilling data for mud motor sliding drilling, and process the data accordingly as actual training samples. Extensively collect may be understood to mean to get a large number of on-site drilling data from one or more different wells.

Information or data collected includes well log, such as from a bottom hole assembly (BHA) and so on. The information may be obtained from the well or from logging companies or other oilfield service companies. The information may be used to fill the data base. Then to build one or more training samples.

The drilling simulation platform may be used to simulate the drilling system under similar or exact conditions, whereby the optimal control logic under each calculation time step is found through repeated calculations for a long time, and then the simulation training samples are obtained. As a large number of training samples are needed. If there are not enough satisfied training samples, the drilling simulation platform is a good tool to produce samples. The simulator can iterate a certain drilling condition to get an appropriate control strategy

A support vector machine (SVM) classification method may be used to classify the test samples, classify the main difficulties in sliding drilling, and use different control parameters for different well conditions.

Test samples is training sample.
Support Vector Machine (SVM) is a small sample machine learning method based on statistical learning theory.
A classification method based on support vector machine (SVM) may be used to classify the training samples.

The system 200 may include the use of a deep learning model. This may include the use of training samples to train the model, use the corresponding method (such as a supervised learning method) to perform iterative training, update the algorithm parameters, and obtain the corresponding parameters such as the connection weight of the neural network model until achieving optimal control results.

The system 200 may include or be operable with the ability to manually fine-tune the parameters of the algorithm until the algorithm is adjusted to have practical application value. When necessary, some parameters of the algorithm need to be adjusted manually, so that it can adapt well to the actual situation.

The control scheme 203 may include an auxiliary interface unit 214. The control interface unit 214 may be operably connected between an external control module 216 and a control system 210a of a top drive 210 (which may otherwise be part of a drilling unit 201, including derrick, piping, drill string, utility fluids, etc.). The main function of the control scheme 203 is to take over at least a portion of the function from a top drive control system 210a, which may be existing or new. The auxiliary interface unit 214 may be used to avoid frequent connect and disconnect of the control module 216 to the top drive 210. The control module 216 may be generally installed or connected with or in the vicinity of a driller box 211 of the top drive 210.

As the power consumption of the auxiliary interface unit 214 need not be large, a power supply (not shown here) of the top drive drill box 211 might be used to power the auxiliary interface unit 214. The auxiliary interface unit 214 may connect to the top drive control system 210a via an at least one (including one or several) set(s) of multi-core cables 213, or any other cabling, wiring, etc. as needed. A standard connector 215 (e.g., quick connect/disconnect) may be be used for the connection between the multi-core cable 213 and the control module 216 and interface 214. As such, the interface 214 may connect to the control module 216 via an at least one (including one or several) sets of multi-core cables as needed.

FIG. 2C shows the auxiliary interface unit 214 in schematic block diagram. The auxiliary interface unit 214 may be configured to ensure convenience and reliability of disassembly and assembly. As such, one or more quick disconnect connecting points 215 may be used.

In order to transmit a signal (e.g., control signal) of the auxiliary interface unit 214 to the top drive 210, a communication module 217 may be used. The communication module 217 may be configured for communication to/from the auxiliary interface unit 214. Information and other parameter data from the top drive 210 may be communicated to the auxiliary interface unit 214 via the communication module 217.

The function of the communication module 217 may be contemplated as being similar to that of CPU, which can receive signals from external control devices (e.g., through network lines). The signal transmission module may transmit signals to the top drive according to the requirements of communication module (e.g., 4-20 mA or 0-10 V signals may be sent according to different top drive). The communication module need not be directly connected with the top drive, but it can store the related information of the top drive, such as brand, characteristics and so on, in the memory, including in advance. When the external control device is connected to the auxiliary device, the communication module will transmit the information and characteristics of the top drive to the external control device for optimizing the control strategy.

To facilitate acquisition of a top drive signal [the top drive signal may include the status information of the top drive and the field information measured by the top drive. The top drive status information may generally include: the top drive drill box knob position (e.g., operation mode position, forward and reverse position, brake position, handwheel zero position, etc.), the top drive drill box status indicator (e.g., top drive standby indicator, operation status indicator, brake status indicator, etc.)], a signal acquisition module 218 may be used. The signal acquisition module may be operable for measuring digital or analog signals of top drive (common analog signals are 4-20 mA, 0-10V signals), which may be used to acquire the information of the top drive.

To facilitate control of the top drive 210 by the auxiliary interface unit 214, a signal transmission module 219 may be used. The signal transmission module 219 may be operable for sending digital or analog signals to the top drive (common analog signals are 4-20 mA, 0-10V signals), which is used to control the top drive to make corresponding actions.

To facilitate other functions, such as, for example, filtering, signal changes, etc., an arithmetic module 220 may be used. The arithmetic module 220 may be an independent module, or may be programmed by using CPU in communication module. Specific calculation method may include limiting filtering, median filtering or various average filtering algorithms.

To facilitate the data recording of operation and performance of the top drive 210 and/or record other top drive related information and setting parameters, a memory module 221 may be used. The memory module 221 is responsible for recording the related information of the top driver, such as brand, characteristics and so on.

Although not shown here, a power supply may be used. In an embodiment, the power supply of the auxiliary interface unit 214 may be from the top drive, such as from the top drive control module (via connector, such as multi-core cable).

### Example Operation

A non-limiting example of connection, operation, and use of the control scheme 203 now follows in order to make the above features and advantages of the present disclosure more apparent. The control scheme 203 may include one or more characteristics as set forth and described.

The control module interface 214 may be a pre-installed module, whereby the interface 214 may be installed in the top drive drill box 211, between the control module 216 and the control system 210a of the top drive 210.

The control module 216 may be customized according to the actual situation or needs of the top drive (e.g., customized software and hardware) to ensure that the signal communication from and to the control module 216 is stable and correct.

After completion of coupling the control module interface 214 with the top drive control 210a, all functions and operations of the top drive 210 may remain unchanged whether or not the control module 216 is connected or active.

The control module interface 214 and the control module 216 may be connected through various connections, such as a standard quick connector. Such a connection may ensure plug-and-play, standardize on-site operation, and ensure top drive and drilling safety.

The control module interface 214 may receive an instruction from the control module 216 during operation and/or may simultaneously send a control command to the top drive control system 210a.

Once the interface 214 is connected, any data signal from the top drive 210 may be collected, stored, recorded, processed, etc. Any data signal from the top drive 210 may thus be communicated, transmitted, etc. to the control module 216, including simultaneously, directly, or indirectly.

A user or operator (not shown) may input any number of various features and related information of the top drive 210 into the control interface 214. When the control module 216 is connected to the interface 214, the control module 216 may (through manual or automatic operation) read the data information from the interface 214. The control scheme 203 may be operable to then makes necessary adjustments to the control logic of the control module 216 by using this information.

In the event the interface 214 is used independently (e.g., with the module 216 connected or operating), the interface 214 may systematically and/or continuously monitor and record the top drive operation signals in the drill box 211. In embodiments, information data—real time or recorded—may be output in various form, such as digital display or reports, which may be used for users' analysis. This information may also be used to update the control system of the top drive 210. When the characteristics or performance of the operation of the top drive 210 change (such as change a module), the relevant settings of the control scheme 203 may be readily updated.

The control module interface 214 may have a modular design, which makes the connection of the signal (or data transfer) lines between the control scheme 203 and the top drive 210 simplified, and mitigates or reduces human error.

Embodiments herein provide a top drive control scheme with method of use and operation. The control scheme 203 may communicate with the top drive control system 210a to obtain corresponding on-site measurement parameters, and also the control scheme 203 may control (or be used to control) the top drive 210, including manually or automatically in accordance with the disclosure.

Various on-site measurement parameters collected by the control scheme 203 may be in parallel with those collected by the top drive control system 210a. Therefore, even if the scheme 203 does not take over all or part of the control authority of the top drive control system 210a, the signal acquisition activities of the top drive and the drilling process can be continued.

The acquisition site parameters of the scheme 203 are not limited to the existing parameters of the original top drive control system 210a. For example, a sensor (not shown here) may be added or used to measure and collect signals that are not available in the original top drive control system 210a.

After the control module 216 operates to complete the acquisition of any given data signal, the data signal may be selectively recorded. Any signal recording may be according to requirements, and the time and frequency of recording may also be set or modified according to requirements.

FIGS. 2D and 2E together show the control module 216 (or scheme 203 understood as a whole) of the present disclosure may include one or more of the following: a control box (or cover, shell, exterior, housing, etc.) 230 (which may include a front portion 237 and back portion 238 releasably coupled together), a control system central processing unit (CPU) 223, an power supply module (e.g., AC/DC) 225, a data acquisition module 226, a data output module 227, an (external) data conversion module 228, a relay 224, a (touch) display and input module 231, an operation (or front) panel 232, an indicator light 233, an emergency stop button 234, a pressure-proof module 235, and a signal and/or power line input/output, interface, etc. 236. As may be desired there may be multiple of these components, or other components not listed, but otherwise suitable for the operation and use of the control scheme 203.

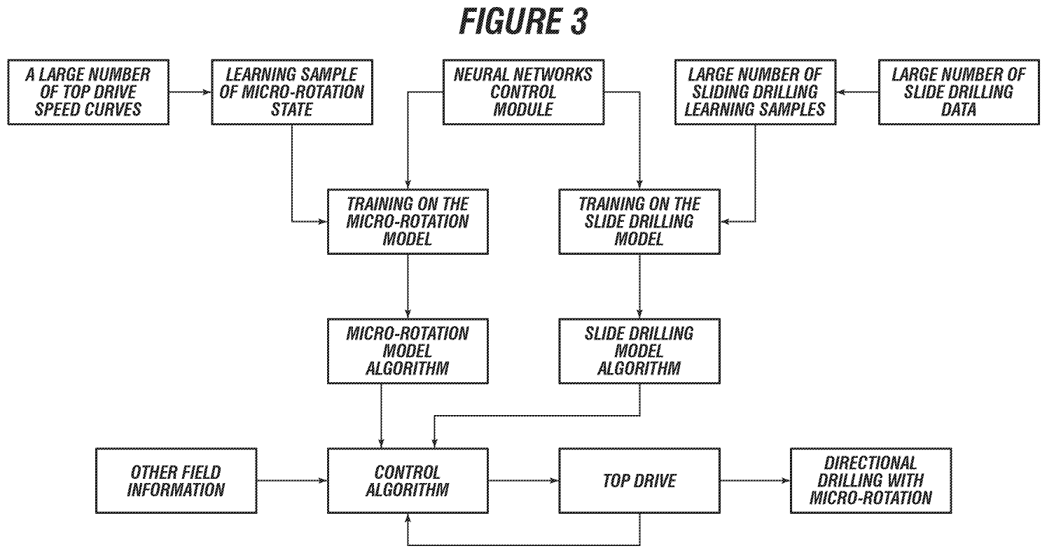

Referring now to FIG. 3, a schematic flow diagram of a control scheme, in accordance with embodiments disclosed herein, is shown. Embodiments herein may be suitable to reduce static friction that may be at the maximum during sliding drilling. The entire drill string may be rotated to achieve a micro-rotating drilling state, and the tool (bit) face may be slightly changed. In order to maintain the sliding effect, the tool face may need to be kept within a predetermined range of orientation.

The micro-rotating drilling state may be a critical aspect of the overall drilling state. The micro-rotation may refer to a very slow or non-uniform rotating speed of the drill string. In such an instance, the maximum torque setting of the top drive may be below the rotating torque. The rotating torque is the torque of the top drive during rotary drilling, of which the value may be in constant fluctuation (albeit within a certain range).

Embodiments herein of the control scheme provide for control of the drill string to reach the micro-rotatory state by taking over at least some or part of the top drive functions and continuously controlling the maximum torque setting and the maximum speed setting value of the top drive with program functionality or algorithm.

The functions of the top drive taken over includes one or more of the following: the maximum torque setting, the maximum speed setting, forward and reverse switching, braking, top drive angle signal, tool face information, pump pressure, pump pressure difference, hook load, weight on bit, with others yet possible and applicable.

The control scheme may monitor signals (i.e., data, information, etc.) in the drilling process in real time.

Signal acquisition during the drilling process mentioned herein may include, without limitation, one or more of the following: top drive torque signal, speed signal, top drive angle signal, brake state, top drive working state, forward and reverse state, speed zero signal, tool face information, pump pressure, pump pressure difference, hook load, weight on bit, etc., and so forth.

The control scheme may be operable to obtain relevant signal information of the drill site as may be desired or necessary. The rig site related information mentioned above may include, without limitation, one or more of the following information: drill pipe size, well depth, well true vertical depth, inclination, drill string information, drilling fluid, etc.;

With enough signal information acquisition of the drilling process and the relevant information of the field, the control scheme may take over part of the top drive functions and achieve the real-time control of the top drive by transmitting a control signal, thereby achieve the micro-rotatory state during directional drilling.

In some instances, there may be insufficient wellsite conditions, and some signals or information may not be available for the control scheme. In this event, the control scheme may open one or more internal parameters to a user (e.g., operator, programmer, etc.) to assist the operation of the control scheme and compensate for the lack of signal or information.

To facilitate control of the tool surface within a desired target sector, the control scheme may be operable to cause release of the torque of the top drive after each tool face correction to avoid excessive tool face change.

Generally, the tool face may reversely deflect under the action of the biting effect by the drill bit. Therefore, the control scheme may control the top drive according to the actual situation of the operation. The logic of the control may be as follows: the control scheme controls the top drive to make the forward micro-rotation action or reverse micro-rotation action until the operation is completed as desired.

The forward micro-rotation action may allow to control the top drive to perform a forward rotation to a micro-rotation state, and then release the torque of the drill string. The reverse micro-rotation action may allow to control the top drive to perform reverse rotation to the micro-rotation state, and then release the torque of the drill string.

The final action may be forward micro-rotation actions only, or may be reverse micro-rotation actions, or may be performed alternately between one or several forward micro-rotation actions and one or several reverse micro-rotation actions. The ratios of different action types are determined by the control scheme based on the actual situation on site.

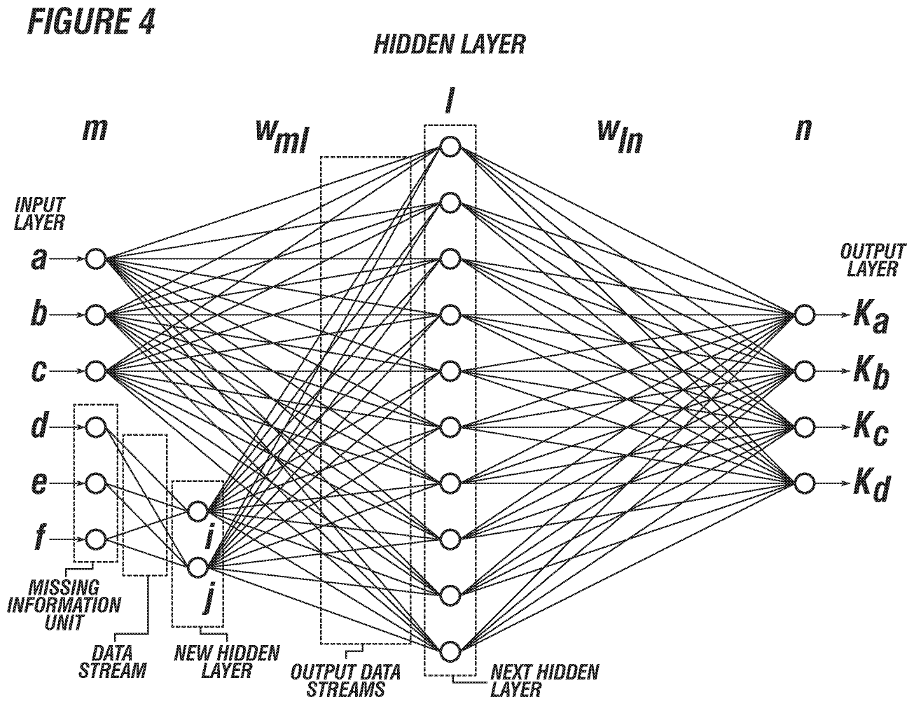

Referring now to FIG. 4, a network control scheme configured to open an at least one hidden layer illustrative of embodiments disclosed herein, is shown.

Once one or more aspects of the data acquisition is completed, the control scheme for the surface steering system may be completed. The control scheme (including one or more sets of control algorithms) may be considered the influence of various aspects in the drilling system.

What may be influenced includes effects from the formation, the rig drilling tool, and real-time parameters from the drilling process.

In embodiments, the control scheme may need external information for the use as one or more inputs to the algorithm. While not limited, the external information may pertain to one or more of the following: formation information, drilling performance, drilling tool combination, real-time torque, real-time rotation speed, real-time pump pressure difference, real-time tool surface information, and the like.

In some instances, it may be the case that some desired information may not be provided on site where the drilling system is operating. In addition or the alternative, some related real-time information may not be acquired through real-time automatic communication. Such instances may be problematic. When this occurs, the system may include the use of a solution for further optimizing the deep learning model.

The solution may include one or more of the following: investigate the situation on site and determine the information that may be difficult to obtain on the site (missing information); select information that may be related to the control scheme. For such missing information, the control scheme may replace it with a default value without external information input; for any remaining missing information, add a hidden layer in the algorithm model to specifically handle such missing information with strong association.

In aspects, the added hidden layer may only obtain a data stream from the missing information unit. The hidden layer may output data streams to all or any of the cells of the next hidden layer. FIG. 4 shows an example.

The control scheme for the system may be designed according to the scheme described herein. The control scheme may thus be suited to adapt to the scene with missing information. For example, when the external information is not missing, the control scheme may be executed according to a normal program operation.

However, in the event the external information is missing, the control scheme may be opened or accessed by a user (e.g., operator) in order to manually adjust one or more added hidden layer values according to on-site conditions.

As illustrated in FIG. 3, “a, b, c, d, e, f” may be considered respective input conditions, and “Ka, Kb, Kc, Kd” may be considered output parameters. The control scheme may be configured for the calculation of output parameters in real time according to the input conditions.

Eventually, the action of an actuator (i.e., control effect) may be determined by one or more of these output parameters (or parameter equations). When the input layer may be missing (partially or otherwise), embodiments herein provide for the optimized network controls scheme. For example, when the input parameters are missing, such as “d, e, f” are missing, the control scheme may open up the new hidden unit in the hidden layer. The assignment authority of i, j may be adjusted by the user according to the on-site conditions, which facilitates to meet the enforceability of the control scheme.

The addition of the opening new hidden layer units to users (rather than directly opening the input layer) provides several benefits. First, it is inconvenient in the actual field to input more than one or two items in the missing units of input layers. While the number of items in the new hidden layer units can be controlled within one or two.

Second, the missing input layer information may include unit conversion, numerical upper and lower limits, etc., and the newly added hidden layer unit can be agreed as a dimensionless positive number within a certain range, which may reduce the risk of operational errors.

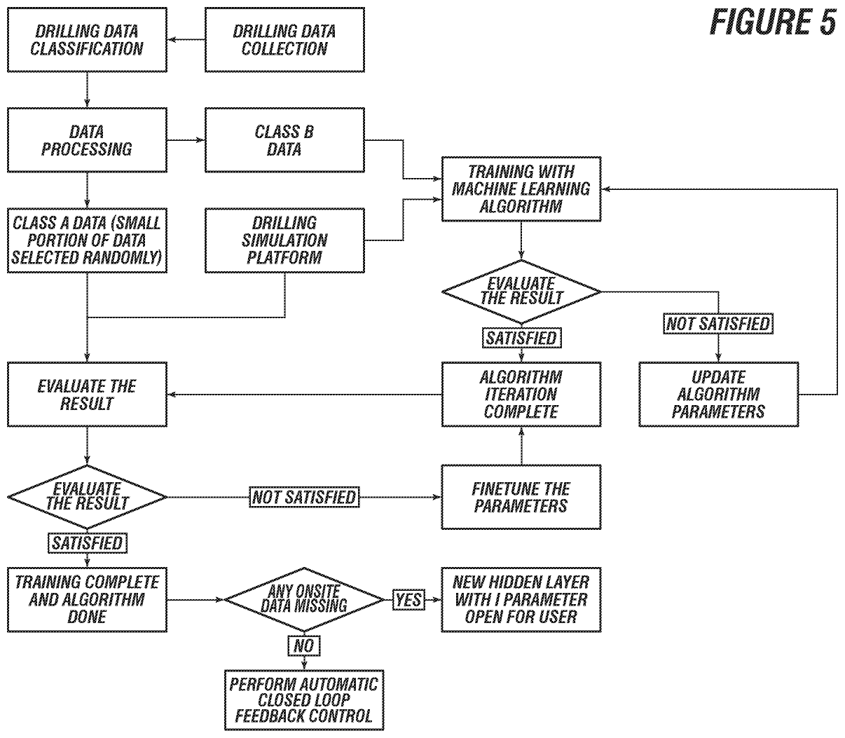

Referring now to FIG. 5, a logic circuit decision tree operable as part of a network control scheme, according to the embodiments of the disclosure, is shown. As illustrated and previously touched on, the control scheme (203) may include various hardware and software operable together as an overall system or logic circuit in which logic of the present disclosure may be implemented.

The control scheme may be programmable and compatible to various computer devices that include, for example, PCs, workstations, laptops, mobile devices, cell phones, tablets, PDAs, palm devices, servers, storages, and the like. Generally, in terms of hardware and related architecture, the logic circuit may include one or more microcontrollers, memory or data storage, and one or more I/O devices (not shown), which may all be operatively communicatively coupled together, including such as circuitry, pins, and via a local interface (not shown).

The control scheme may include a microcontroller (or sometimes just ‘controller’) that may be a hardware device configured for execution of software (programming, computer readable instructions, etc.), which may be stored (programed thereinto) in a controller memory. The controller may be any custom made or commercially available processor, a central processing unit (CPU, 223), a digital signal processor (DSP), or an auxiliary processor among several processors associated therewith.

The control scheme may include any one or combination of random access memory (RAM), dynamic random access memory (DRAM), static random access memory (SRAM), ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, and so forth. Moreover, the control scheme may incorporate electronic, magnetic, optical, and/or other types of storage media.

Software for the control scheme memory may include one or more separate programs, each of which may include an ordered listing of executable instructions for implementing logical functions. Software in the controller memory may include a suitable operating system (OS), compiler, source code, and/or one or more applications in accordance with embodiments herein. Software may be an application (“app”) that may include numerous functional components for implementing the features and operations of embodiments of the disclosure.

The OS may be configured for execution control of other computer programs, and provides scheduling, input-output, file and data management, memory management, and communication control and related services. In aspects, the app may be suitable for implementation of embodiments herein to all commercially available operating systems.

Software may include an executable program, script, object code, source program, or any other comparable set of instructions to be performed.

Software may be written as object oriented programming language, which may have classes of data and methods, or a procedure programming language, which has routines, subroutines, and/or functions. The programming language may include for example Python, HTML, XHTML, Java, ADA, XML, C, C++, C#, Pascal, BASIC, API calls, ASP scripts, FORTRAN, COBOL, Perl, .NET, Ruby, and the like.

The input/output (I/O) device(s) may include an input device such as, for example, a mobile device, a keyboard, a mouse, a touchscreen, a microphone, a camera, a scanner, and so forth. The I/O device(s) may include an output device such as, for example, a display, a printer, an email, a text message, and so forth. The I/O device may include devices configurable to communicate both inputs and outputs, such as a router, a telephonic interface, a modulator/demodulator or NIC (that may be suitable to access remote devices, other files, devices, systems, or a network), a radio frequency (RF) or other transceiver, a bridge, and so forth. The I/O devices may include one or more components for communicating over various networks, such as the Internet or intranet.

In aspects, external computers (and respective programming) may be communicably operable with the control scheme.

In operation of, the control scheme may may: execute software stored within the memory; communicate data to and from the memory; and/or generally control operations of the logic circuit pursuant to the software.

In Operation (with Logic)

The operation of the logic circuit may be further understood with an explanation of the tree diagram of FIG. 5. The tasks are numbered in above the task name. While embodiments herein are not meant to be limited, FIG. 5 shows a SVM-based multi-parameter automatic real-time control system developed by the above invention, referred to as SMART (SVM Multi-parameter Automatic Real Time) control system.

Task 1 may include extensive collection of on-site drilling data for mud motor sliding drilling. The on-site drilling data may include drilling information, rig information, and real time data on the drilling process.

Task 2 may include the division of the actual data from Task 1 into two categories according to a certain proportion, randomly select some of the better-performing data as an A-class, and the rest as a B-class import system database. Task 2 may further include distributed data processing, including data sorting, data format conversion, data classification, and so on.

Task 3 may include the setup, or performance, of secondary programming for the existing drilling dynamic analysis simulation software, and model the Class B [or B-class] working conditions in the above database. This model may consider and utilize the effects of various influencing factors, including lithology differences, drill string, the drive system, the components of the downhole assembly, and the overall behavior of the drilling system in a dynamic drilling environment. The model can simulate various states over time throughout the drilling process, such as quantification of vibration, module, torque distribution, and ROP.

The establishment of this system is based on the model of the drill bit and the interaction between the drill string and the formation, and the finite element analysis of the entire drilling assembly is based on the model. At the same time, the impact of different operating parameters and drilling tool combinations is also reflected in the model considerations and simulation algorithms In the simulation process, the model may analyze the parameters of the formation, such as the compressive strength of the formation, the dip angle of the formation, the heterogeneity and the anisotropic formation to obtain accurate models and simulation results.

Task 4 may include the establishment of a set of an evaluation system. The evaluation system may comprehensively evaluate the advantages and disadvantages of the control scheme from the aspects of ROP, drilling efficiency and sliding ratio.

Task 5 may include the use of a machine learning algorithm (MLA). The MLA may perform a simulated sliding drilling operation in the above model, and performing iterative training with reference to the above evaluation system to update the algorithm parameters.

Task 6 may be performed after the algorithm training. Task 6 may include use of the algorithm for the Class A condition in Task 2, and examine the effect of the control, and manually fine-tune the parameters in Task 5 until necessary, until the algorithm achieves satisfactory results.

Task 7 may pertain to real-time conditions at the drilling site. As such, this task may relate to the choice to perform automatic control or open the i parameter to control when data (e.g., the “real-time pump pressure difference or real-time tool surface information”) is missing.

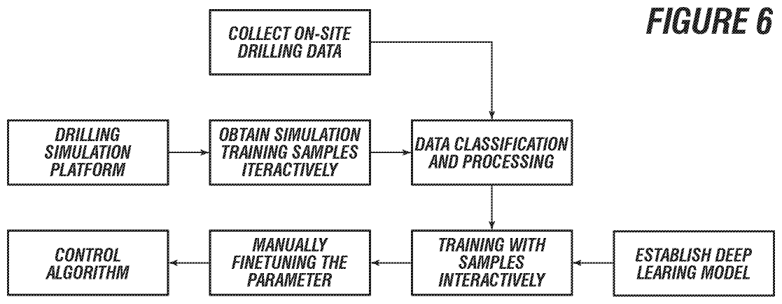

Referring now to FIG. 6, steps for a method of creating and using a control scheme, according to embodiments disclosed herein, is shown.

The control scheme(s) of the present disclosure, including any control scheme (e.g., 203) described herein, may be created and/or used according to one or more of the following steps.

The method may include one or more steps of: collecting a set of on-site drilling data from the drilling operation; and dividing the set of on-site drilling data into an at least two class categories according to predetermined selectivity definitions. One of the class categories may be an A-class comprising better performing data.

The steps may include performing distributed data processing comprising an at least one of: data sorting, data format conversion, data classification, and combinations thereof; and processing the set of data as an at least one training sample.

Other steps may include to establish a set of evaluation system to comprehensively evaluate advantages and disadvantages from aspects of ROP, drilling efficiency, and sliding ratio associated with the drilling operation. Yet another step may include to establish a deep learning module by using the at least one training sample to train the deep learning module, such as through an iterative training mode.

In aspects associated with the control scheme, a drilling simulation platform may be used to simulate at least a portion of the drilling operation. An optimal control logic under a calculation time step may be found from repeated calculations over a pre-determined time, which may obtain or yield an at least one simulation training sample.

A support vector machine classification method may be used to classify the at least one training sample. The SVM classification may use an at least one control parameter to account for varied well conditions.

Any control parameter may include an at least one of: effects from a surrounding formation, a drilling operation tool, a real-time parameter from the drilling operation, and combinations thereof.

The method may include one or more (sub)steps, such as: determining a set of missing information by adding a hidden layer in the module to specifically handle the determining the set of missing information via strong association. In aspects, the hidden layer may get or obtain data from a missing information unit. As such, the hidden layer may output one or more data streams to any cell of a next hidden layer.

The method may include the step of: using machine learning control to perform a simulated sliding drilling operation. The method may include (such as via machining learning) the step of to perform iterative training with reference to the set of evaluation system in order to update the control scheme parameters.

In aspects, after the using machine learning step, the method may include using the A-class data in a manner to fine tune the machine learning control.

### Advantages

Embodiments of a control scheme for a drilling operation of the present disclosure may provide for a control scheme that may consider and utilize various factors in the sliding drilling process. The control scheme may be especially suitable for multi-parameter and nonlinear conditions, whereas a conventional scheme utilizes only one.

The control scheme may be based on a large number sample data and drilling simulation platform training. As such, the requirements for a user or operator may be relatively low (such that no or little drilling experience is needed). The user need only give simple instructions. The scheme may adapt to many different kind of complex well conditions. The scheme may beneficially cover a variety of strata and various top drives, and has strong adaptability.

The control scheme may be applied to working conditions in which input information is missing, as in the absence of input information, the scheme only needs to provide fewer parameters (less than the amount of missing information) to run.

A synergistic effect is realized because a more effective control scheme means faster drilling. And even a small savings in drill time of a single well (repeated for multiple wells) results in an enormous savings on an annual basis.

While preferred embodiments of the disclosure have been shown and described, modifications thereof may be made by one skilled in the art without departing from the spirit and teachings of the disclosure. The embodiments described herein are exemplary only and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the present disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A method for creating and using a control scheme for a drilling operation, the method comprising:
collecting a set of on-site drilling data from the drilling operation;
dividing the set of on-site drilling data into an at least two class categories according to predetermined selectivity definitions, whereby one of the class categories is an A-class comprising better performing data;
performing distributed data processing comprising an at least one of: data sorting, data format conversion, data classification, and combinations thereof;
processing the set of data as an at least one training sample;
establish a set of evaluation system to comprehensively evaluate advantages and disadvantages from aspects of ROP, drilling efficiency, and sliding ratio associated with the drilling operation;
establish a deep learning module by using the at least one training sample to train the deep learning module through an iterative training mode;

2. The method of claim 1, wherein a drilling simulation platform is used to simulate at least a portion of the drilling operation, and wherein an optimal control logic under a calculation time step is found from repeated calculations over a pre-determined time in order to obtain an at least one simulation training sample.

3. The method of claim 1, wherein a support vector machine classification method is used to classify the at least one training sample, and to use an at least one control parameter to account for varied well conditions.

4. The method of claim 3, wherein the at least one control parameter comprises an at least one of: effects from a surrounding formation, a drilling operation tool, a real-time parameter from the drilling operation, and combinations thereof.

5. The method of claim 1, the method further comprising the step of optimizing the deep learning module that further comprises the substeps of:
determining a set of missing information by adding a hidden layer in the module to specifically handle the determining the set of missing information via strong association, wherein the hidden layer only gets data from a missing information unit, and wherein the hidden layer outputs one or more data streams to any cell of a next hidden layer.

6. The method of claim 1, the method further comprising the step of: using machine learning control to perform a simulated sliding drilling operation, and perform iterative training with reference to the set of evaluation system in order to update the control scheme parameters.

7. The method of claim 6, the method further comprising the step of: after the using machine learning step, using the A-class data in a manner to fine tune the machine learning control.

8. A method for creating and using a control scheme for a drilling operation, the method comprising:
collecting a set of on-site drilling data from the drilling operation comprising sliding drilling;
dividing the set of on-site drilling data into an at least two class categories according to predetermined selectivity definitions, whereby one of the class categories is an A-class comprising better performing data, and another class category is a B-class;
performing distributed data processing comprising an at least one of: data sorting, data format conversion, data classification, and combinations thereof;
processing the set of data as an at least one training sample;
establish a set of evaluation system to comprehensively evaluate advantages and disadvantages from aspects of associated with the drilling operation;
establish a deep learning module by using the at least one training sample to train the deep learning module through an iterative training mode;

9. The method of claim 8, wherein a drilling simulation platform is used to simulate at least a portion of the drilling operation, and wherein an optimal control logic under a calculation time step is found from repeated calculations over a pre-determined time in order to obtain an at least one simulation training sample.

10. The method of claim 9, wherein a support vector machine classification method is used to classify the at least one training sample, and to use an at least one control parameter to account for varied well conditions.

11. The method of claim 10, wherein the at least one control parameter comprises an at least one of: effects from a surrounding formation, a drilling operation tool, a real-time parameter from the drilling operation, and combinations thereof.

12. The method of claim 11, the method further comprising the step of optimizing the deep learning module that further comprises the substeps of:
determining a set of missing information by adding a hidden layer in the module to specifically handle the determining the set of missing information via strong association,
wherein the hidden layer only gets data from a missing information unit, and wherein the hidden layer outputs one or more data streams to any cell of a next hidden layer.

13. The method of claim 12, the method further comprising the step of: using machine learning control to perform a simulated sliding drilling operation, and perform iterative training with reference to the set of evaluation system in order to update the control scheme parameters.

14. The method of claim 13, the method further comprising the step of: after the using machine learning step, using the A-class data in a manner to fine tune the machine learning control.

15. A method for creating and using a control scheme for a drilling operation, the method comprising:
collecting a set of on-site drilling data for mud motor sliding drilling, wherein the set of on-site drilling data includes information related to at least one of drilling information, rig information, real time data on the drilling operation, and combinations thereof;
division of the set of data from the collecting step into two categories according to a certain proportion, whereby some of the better-performing data is categorized as an A-class, and the rest as a B-class import system database; and
establishing the control scheme based on the model of the drill bit and the interaction between the drill string and the formation, and the finite element analysis of the entire drilling operating,
wherein the control scheme is a SVM-based multi-parameter automatic real-time control scheme.
